(19) United States
(12) Patent Application Publication
(10) Pub. No.: US 2026/0196600 A1
(43) Pub. Date: Jul. 9, 2026

(54) END ARRANGEMENT FOR A BATTERY OF A MOBILITY MACHINE, BATTERY OF A MOBILITY MACHINE, COMPRISING SUCH AN END ARRANGEMENT

(71) Applicant: VALEO EMBRAYAGES, Amiens (FR)

(72) Inventor: Roel VERHOOG, Cergy Pontoise (FR)

(73) Assignee: VALEO EMBRAYAGES, Amiens (FR)

(21) Appl. No.: 19/131,772

(22) PCT Filed: Dec. 18, 2023
(86) PCT No.: PCT/EP2023/086392

§ 371 Date: May 21, 2025

(30) Foreign Application Priority Data
Dec. 23, 2022 (FR) FR2214482

(51) Int. Cl. H01M 10/656; B60L 50/64; H01M 10/613; H01M 10/625; H01M 10/658; H01M 50/204; H01M 50/249

(52) U.S. Cl. CPC H01M 10/656; H01M 10/613; H01M 10/625; H01M 10/658; H01M 50/204; H01M 50/249; B60L 50/64; H01M 2220/20

(57) ABSTRACT

A battery of a mobility machine, including an end arrangement having at least one outer element and one inner element which are arranged to form, in the assembled state, a cellular structure. The inner element has a wall arranged to be in contact with a cell of the battery. A channel for circulating coolant originating in the cells cooperates with a passage in the end arrangement.

The present application relates to the field of batteries for mobility machines, in particular batteries used in an electric vehicle, a hybrid electric vehicle, or a rechargeable hybrid electric vehicle.

As electric or hybrid mobility, notably combining electric and thermal propulsion, becomes more widespread, it is necessary to monitor the capacity, efficiency and service life of the batteries used.

In a known manner, a battery used for an electric or hybrid mobility machine has a plurality of cells.

The curve in FIG. 10 shows the temperature of the 72 cells of a battery in cold weather. It can be seen that the end cells are about 10° C. colder than the central cells. It is known that the performance of a battery is related to the uniformity of the temperature of the cells. The cell with the most divergent temperature has the greatest impact on the performance of the battery.

There is a need to reduce the temperature difference between the different cells of a battery.

Utility model CN216529114U discloses a battery module having a battery end plate having a contact area with the battery cells that is flexible, enabling it to withstand the expansion force generated by the charging and discharging cycles of the battery. After a few cycles, the thermal performance of the end plate deteriorates due to axial contact.

There is a need to improve the battery and notably the existing end plates, in particular to improve the thermal insulation they provide.

To meet some or all of these needs, the invention according to a first aspect relates to a mobility machine battery, including:
a plurality of cells;
a first end arrangement and a second end arrangement, at least one of the first and second end arrangements, preferably both, having at least one outer element and one inner element which are arranged to form, in the assembled state, a cellular structure, the inner element having a wall arranged to be in contact with a cell of the battery;
a channel for circulating coolant originating in or destined for the cells, the channel cooperating with at least one passage in one of the first or second end arrangements, the flow of coolant in the arrangement of one of the first or second end arrangements flowing in the opposite direction to the flow passing between the cells.

Thus, the coolant that has increased in temperature by passing between the cells can advantageously be sent to the channel in the first or second end arrangement so as to heat the end cells of the battery and thus make the temperature distribution of all of the cells more uniform.

The invention relates to an end arrangement for a mobility machine battery having at least one outer element and one inner element which are arranged to form, in the assembled state, a cellular structure, the inner element having a wall arranged to be in contact with a cell of the battery.

The outer and inner elements are distinct, i.e., for the purposes of the present invention, they are manufactured separately, notably by molding, extrusion, or any other appropriate method known to a person skilled in the art.

Each outer and inner element is manufactured as one or more parts, advantageously manufactured as a single part.

According to different variants of the invention, the outer and inner elements are assembled by glueing, force-fitting, hot riveting, snap-fitting, interlocking, clamping by an enveloping structure, or any other suitable method known to a person skilled in the art.

Advantageously, the wall of the inner element is weakly conductive, i.e. made of a material having a low thermal conductivity, notably a material having a thermal conductivity of less than 5 W/m·K, notably a plastic material having a thermal conductivity of less than 5 W/m·K.

In the following description,
the terms horizontal, vertical and lateral relate to the orientation of a battery placed on a flat surface.
the term axial corresponds to a direction along the axis of the battery.

Advantageously, the outer element includes a wall and, in the assembled state, the cellular structure is located between the wall of the outer element and the wall of the inner element.

According to variants of the invention, the cellular structure may form part of the outer element, in particular of a one-piece outer element, the cellular structure being notably integral with the wall of the outer element.

Alternatively, the cellular structure may form part of the inner element, in particular of a one-piece inner element, the cellular structure being notably integral with the wall of the inner element.

According to a further variant, the outer element cooperates with the inner element to form, in the assembled state, the cellular structure.

The end arrangement may include a frame.

The outer element may include a frame, for example forming the frame of the end arrangement.

The inner element may include a frame, for example forming the frame of the end arrangement.

The outer element and the inner element may each include a frame forming, in the assembled state, the frame of the end arrangement.

Depending on the embodiments, the end arrangement according to the invention may alternatively or additionally have one of the following features:
the outer element and/or the inner element has a series of vertical stiffeners, i.e. at least one vertical stiffener, preferably several. Said vertical stiffeners are spaced apart regularly or otherwise along a horizontal dimension of said element.
the outer element and/or the inner element has a series of horizontal stiffeners, i.e. at least one horizontal stiffener, preferably several. Said horizontal stiffeners are spaced apart regularly or otherwise along a vertical dimension of said element.
the outer element and the inner element each include stiffeners, the stiffeners of the outer element and the stiffeners of the inner element being arranged to cooperate with each other. The stiffeners of the outer and inner elements thus form the cellular structure.
at least one of the stiffeners has a thickness less than a gap between the wall of the inner element and the wall of the outer element. For the purposes of the invention, the thickness of a stiffener means its largest dimension measured perpendicularly from the wall of the corresponding element. For the purposes of the invention, the thickness of an element means its largest dimension measured perpendicularly from its wall.
at least one height of one of the vertical stiffeners is less than a height of the end arrangement. For the purposes of the invention, the height of a stiffener means its maximum vertical dimension measured parallel to the wall of the corresponding element. In the context of the invention, if the end arrangement includes a frame, the height of the end arrangement is measured inside this frame.
at least one width of one of the horizontal stiffeners is less than a width of the end arrangement. For the purposes of the invention, the width of a stiffener means its maximum horizontal dimension measured parallel to the wall of the corresponding element. In the context of the invention, if the end arrangement includes a frame, the width of the end arrangement is measured inside this frame.
the end arrangement includes, once assembled, at least one passage for circulating a coolant, notably a gas or a liquid. Said passage is notably arranged to circulate, from at least one inlet, a coolant originating in or destined for cells of the battery. The passage may be located between two vertical or horizontal parallel stiffeners. The circulation of the fluid may be vertical or horizontal. The coolant is for example a gas such as air or water, notably with a dielectric additive.
the outer element, notably its wall, and/or the inner element, notably its wall, includes at least one orifice connected to the fluid-circulation passage.
the wall of the outer element and the wall of the inner element cover at least half or even three quarters of the surface of the end element.
the end arrangement, in particular the inner element, has at least one coolant inlet.
the end arrangement, in particular the outer element, includes at least one coolant outlet, notably an air or liquid outlet.
the outer element and the inner element are identical, notably arranged to be assembled in a mirrored arrangement or head-to-tail. For the purposes of the invention, identical means that they are manufactured using the same manufacturing process, notably from the same mold. The outer element and the inner element thus have the same dimensions. They may be of the same material or of different materials, for example the inner element may be of a material that is more thermally insulating (lower thermal conductivity) than the outer element. Alternatively or additionally, the outer element may be made of a material that is more rigid than the inner element, the outer element for example being injected with a fiber-reinforced material while the inner element is not. In this example, they can be of different colors to differentiate them. Identical outer and inner elements are for example assembled in a mirrored arrangement or head-to-tail. For the purposes of the invention, identical outer and inner elements may have a structural difference corresponding to an additional manufacturing step. For example, an orifice may be added to create an inlet or outlet for the coolant.

According to another aspect, the invention relates to a mobility machine battery, including a plurality of cells, a first end arrangement and a second end arrangement, at least one of the first and second end arrangements being an end arrangement as described above. Preferably, both end arrangements, the first and the second, are end arrangements according to the first aspect of the invention.

The battery is not limited to a particular voltage. It can be “high voltage” or “low voltage”.

The battery may be cooled by air or water, notably with a dielectric fluid.

Depending on the embodiments, the battery according to the invention may alternatively or additionally have one of the following features:
the first and second end arrangements are fastened to the plurality of cells by at least one holding bar. Said holding bar preferably has at least one oblong hole. This shape is designed to take up the axial loads of the end arrangements. It facilitates axial clearance or axial compression of the cells. It allows clamping in a range of relative positions.
the holding bar or bars are preferably made of metal.
the mobility machine battery includes a channel for circulating coolant in the end arrangement, notably for air or liquid, originating in or destined for the cells. The channel is notably arranged to cooperate with at least one orifice of an end element. Said orifice may be arranged to act as an inlet and/or outlet. Advantageously, the flow of coolant in the end arrangement flows in the opposite direction to the flow passing between the cells. This notably improves thermal insulation. The flow in the end arrangement thermally insulates the end cell in contact with the wall of the inner element.

According to a further aspect, the invention provides a mobility machine battery having a plurality of cells, a first end arrangement and a second end arrangement, a coolant circulation system cooperating with at least one of the first and second end arrangements, the flow of coolant in at least one of the end arrangements flowing in the opposite direction to the flow passing between the cells.

Other features, details and advantages of the invention will become more clearly apparent from reading the description set out below by way of indication with reference to drawings, in which:

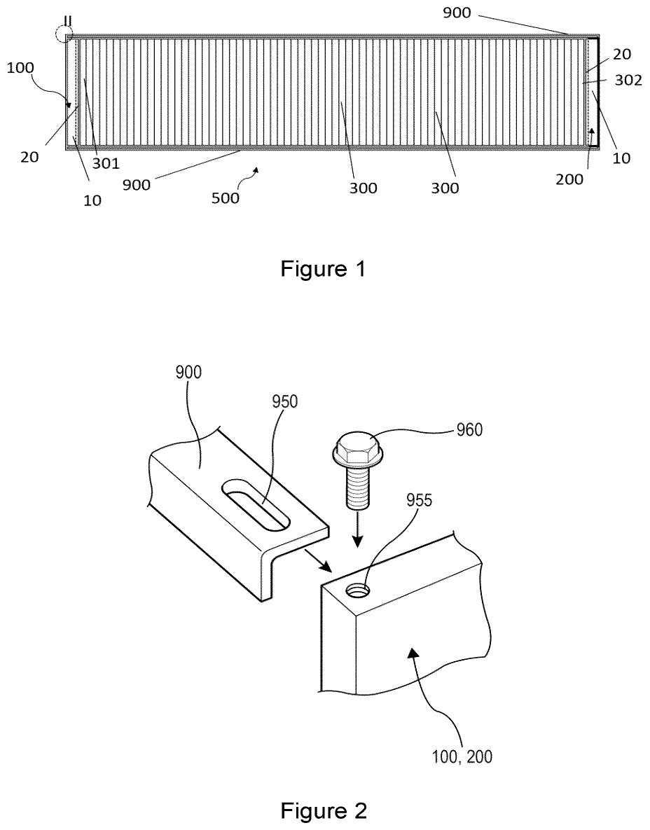

FIG. 1 illustrates an example battery according to the invention,

FIG. 2 is an exploded view of the detail II in FIG. 1,

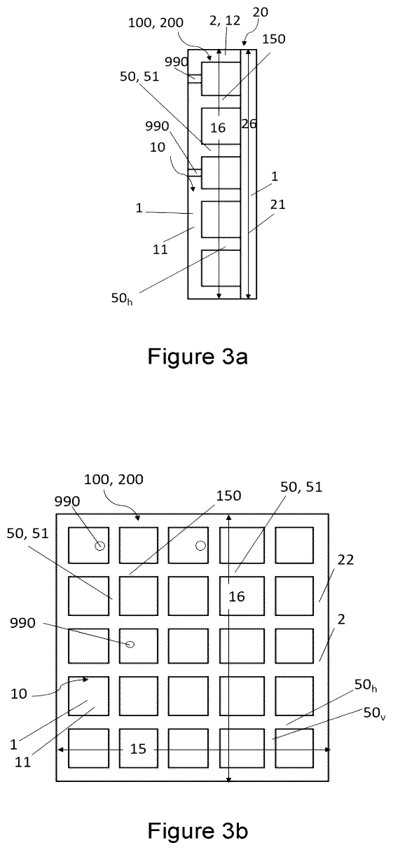

FIG. 3a is a partial sectional view of an end arrangement according to a first embodiment of the invention,

FIG. 3b is a front inside view of the outer element of the end arrangement in FIG. 3a,

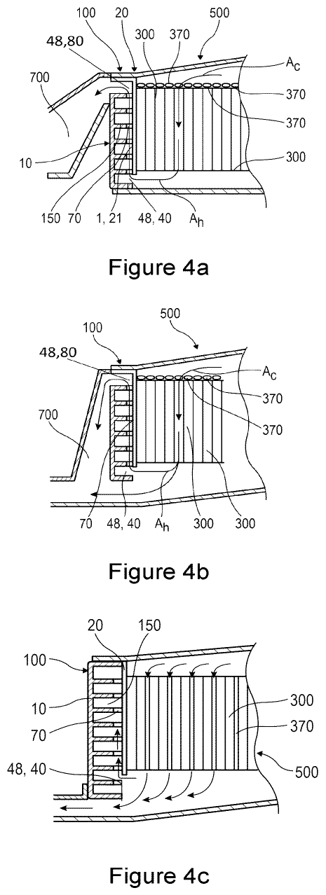

FIGS. 4a to 4c are partial sectional views of details of the battery according to variants of the invention,

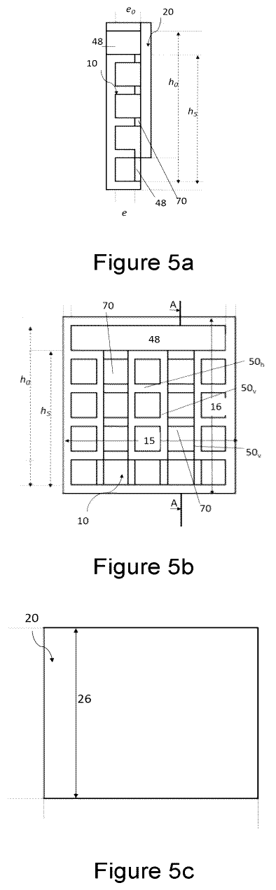

FIGS. 5a to 5c are different views of end arrangements according to the invention,

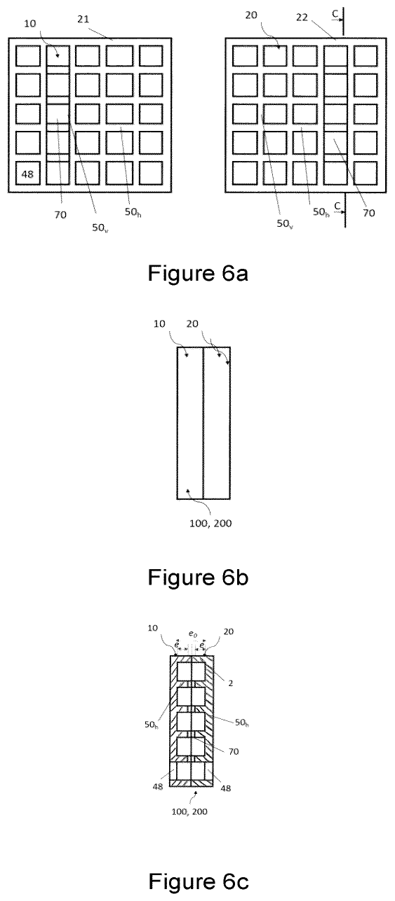

FIGS. 6a to 6c are different views of outer and inner elements of an example end arrangement according to the invention,

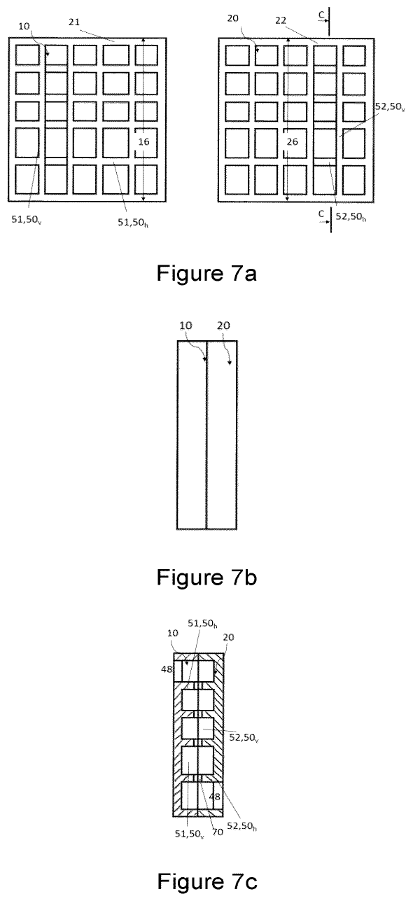

FIGS. 7a to 7c are equivalent to FIGS. 6a to 6c for the outer and inner elements of another example end arrangement according to the invention,

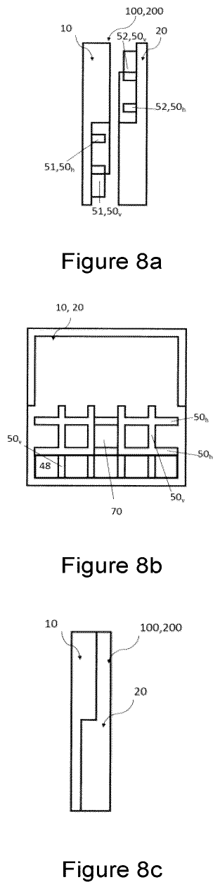

FIGS. 8a to 8c illustrate the outer and inner elements of a further example end arrangement according to the invention, and

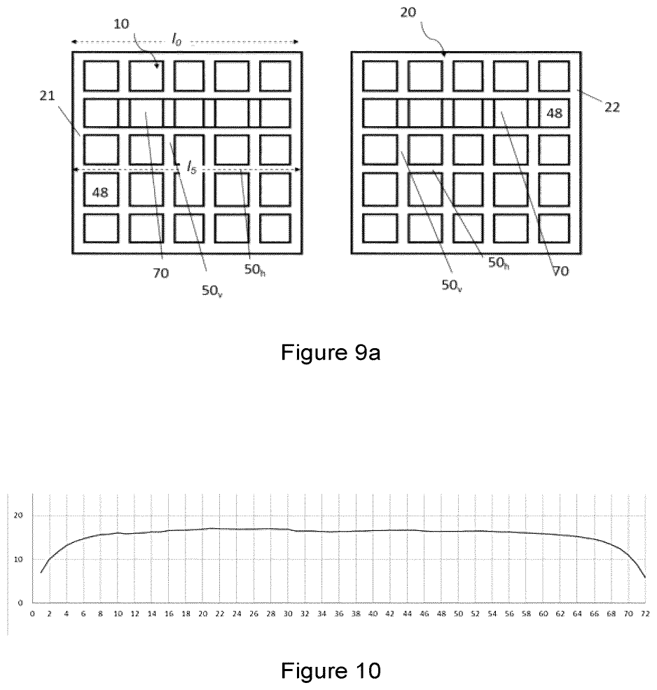

FIG. 9a corresponds to FIG. 6a for an alternative end arrangement according to the invention,

FIG. 10 is a graph illustrating the temperature distribution in the cells of the battery.

In these figures, similar elements have the same reference signs.

The following embodiments are examples. Although the description refers to one or more embodiments, this does not necessarily mean that each reference relates to the same embodiment, or that the features apply only to a single embodiment. Individual features of different embodiments can also be combined or exchanged to provide other embodiments.

In the description, certain objects may be indexed, such as for example first object or second object. In this case, such indexing merely differentiates and denotes objects that are similar but not identical. This indexing does not imply that one object takes priority over another and such denominations can easily be inverted without departing from the scope of the present description. Likewise, such indexing does not imply any chronological order.

The mobility machine battery 500 illustrated in FIG. 1 includes a plurality of cells 300, 72 in the example, a first and a second end arrangement 100 and 200. Each end arrangement 100, 200 includes an outer element 10 and an inner element 20 that are distinct. Each inner element 20 includes a wall 1, 21, preferably weakly conductive, which is in contact with an end cell 300 of the battery 500. The first end arrangement 100 is thus in contact with a first end cell 301 of the battery 500, and the second end arrangement 200 is in contact with a second end cell 302 of the battery 500.

The end arrangements 100, 200 are in this case fastened to the plurality of cells 300 by four holding bars 900 located at the four crests of the plurality of cells 300. Advantageously, the holding bars help both to hold the end arrangements and to hold the cells together, next to each other. The holding bars make it easier to manage the expansion of the cells.

FIG. 2 is a perspective exploded view of various components of the battery in FIG. 1. It shows the fastening of one of the holding bars 900 to each first and second end arrangement 100 and 200 in the example illustrated. The holding bar 900 is in this case an angle iron formed by a lateral portion at right angles to a horizontal portion. The holding bar 900 has a fastening hole 950, advantageously in this case an oblong hole. A screw 960, or a rivet, in particular a self-locking rivet, ensures the fastening through the oblong hole 950 and a corresponding hole 955 in the end arrangement. Said hole 950 is in this case located on the horizontal portion of the holding bar 900. In a variant (not illustrated), it is located on the lateral portion. According to a further variant (not illustrated), the holding bar includes a hole on a horizontal portion and a hole on a lateral portion.

FIG. 3a is a partial sectional view of an end arrangement 100, 200 according to a first embodiment. The end arrangement 100, 200 includes a frame 2, two walls 12 and 11 and a cellular structure 150 formed by stiffeners 50.
While the inner element 20 is formed by the wall 21, the outer element 10 includes the wall 11 and a frame 12 forming the frame 2 of the end arrangement and also stiffeners 51.

The wall 11 further includes fastening holes 990, for example to enable sheaths or other parts of the battery to be fastened to the wall 11.
As shown in FIG. 3b, the outer element 10 also includes stiffeners 51, more particularly in this case a series of vertical stiffeners 50ᵥ spaced apart regularly over a horizontal dimension 15 of the element 10 and a series of horizontal stiffeners 50ₕ spaced apart regularly over a vertical dimension 16 of the element 10.

The batteries 500 partially illustrated in FIGS. 4a to 4c include a channel 700. The fluid thus discharged, in this case air, comes from the cells 300 of the battery 500, enters the end arrangement 100 via the inlet 40, passes through the passage 70, and exits via the outlet 80 into the channel 700. Advantageously in this case, the cold fluid A_{c}, shown with dotted lines, passes through the cells 300. It is notably guided by grids 370 positioned between two adjacent cells 300. Its temperature increases in contact with the cells, and the coolant thus heated Aₕ is shown with solid lines. Such fluid circulation in the cells and then through the end arrangement improves the performance of the battery 500. The cooling of the battery is facilitated while making cell temperatures more uniform.

While in the example in FIG. 4a the coolant originating in the cells 300 that is discharged through the channel 700 passes in full through the end arrangement 100, in the variant in FIG. 4b, a portion of the fluid heated by the cells is discharged directly into the channel 700 and only a portion passes through the end arrangement 100.

In the variant in FIG. 4c, a portion of the coolant heated by the cells is discharged directly into the channel 700 and a portion enters the end arrangement 100.

Similarly, the second end arrangment 200 (not shown in FIGS. 4c to 4c) may include a channel 700.

In another variant, a portion of the coolant heated by the cells passes through the end arrangement 200 before being discharged directly into the channel 700 located on the side of the first end arrangement 100.

The remaining figures illustrate various embodiments of the cellular structure 150 and of the passage 70.

The end arrangement 100, 200 illustrated in FIGS. 5a to 5c includes, once assembled, a passage 70 for circulating coolant originating in or destined for the cells of the battery between orifices 48. These orifices are arranged to act as inlet or outlet, depending on the battery. In the example described, the end arrangement 100, 200 includes two passages 70 as shown in FIG. 5b. These passages are located between two vertical stiffeners 50ᵥ. The horizontal stiffeners 50ₕ of the outer element 10 have a variable thickness e. At the passages 70, this thickness e is less than a gap e₀ between the wall 21 of the inner element 20 and the wall 11 of the outer element 10, as shown in FIG. 5a, which is a sectional view of the end arrangement 100, 200 taken along A-A. In addition, FIGS. 5a and 5b show that the height h₀ of the outer element 10 is greater than the height h₅ of the vertical stiffeners 50ᵥ. The outer element 10 has an orifice 48. The inner element 20 does not entirely cover the surface of the end arrangement 100, 200, i.e. in this case the surface of the inner element 20, in order to create a second orifice 48 in the end arrangement 100, 200. The wall of the inner element 20 in this case covers four fifths of the surface of the end arrangement 100, 200. More generally, the walls of the outer and inner elements advantageously cover at least half or even three quarters of the surface of the end arrangement.

In the example end arrangements 100, 200 described below, the outer element 10 and the inner element 20 each include stiffeners 50. The stiffeners 51 of the outer element 10 and the stiffeners 52 of the inner element 20 are arranged to cooperate with each other. They thus form the cellular structure 150.

In the examples illustrated in FIGS. 6a to 6c and 7a to 7c, the outer and inner elements 10 and 20 are identical. In this case, they are arranged to be assembled in a mirrored arrangement.

The outer and inner elements 10 and 20 of the end arrangement 100, 200 illustrated in FIGS. 6a to 6c include a series of vertical stiffeners 50ᵥ and a series of horizontal stiffeners 50ₕ. The horizontal stiffeners are in this case spaced apart regularly over a vertical dimension 16, or 26, of the corresponding element.
FIG. 6c is a sectional view of the assembled end arrangement 100, 200, taken along C-C. Once assembled, the end arrangement 100, 200 includes, as illustrated in FIG. 6c, a passage 70 located between the outer and inner elements 10 and 20 for circulating coolant between two orifices 48. The orifices 48 are in particular arranged so as to be able to act as an inlet or outlet for the coolant. Depending on the battery, the coolant originating in the battery cells can flow into the end arrangement 100, 200. In a variant battery, the coolant flows from the outside into the end arrangement 100, 200 and exits towards the cells of the battery. The passage 70 is located between two vertical stiffeners 50ᵥ. The horizontal stiffeners 50ₕ of the outer and inner elements 10 and 20 have a variable thickness e. This thickness e is in this case equal to half the gap e₀ between the wall 21 of the inner element 20 and the wall 11 of the outer element 10, except around the passage 70. To form the passage 70, the thickness e is then strictly less than half the gap e₀.

The outer and inner elements 10 and 20 of the end arrangement 100 illustrated in FIGS. 7a to 7c also include a series of vertical stiffeners 50ᵥ and a series of horizontal stiffeners 50ₕ. The horizontal stiffeners are in this case spaced apart irregularly over a vertical dimension 16, or 26, of the corresponding element. In this example, the outer and inner elements 10 and 20 are manufactured from a single mold and the orifices 48 are then cut out before assembly.

The outer and inner elements 10 and 20 of the end arrangement 100 illustrated in FIGS. 8a to 8c are also identical. In this case, they are arranged to be assembled head-to-tail. FIG. 8a is a front view of one of the outer and inner elements 10 and 20. They are placed head-to-tail before assembly, as illustrated from the side in FIG. 8b. They are finally assembled as shown in FIG. 8c. The orifice 48 of each element is made at the time of manufacture of the outer and inner elements 10 and 20, directly at the time of molding or in a subsequent step.

In the example illustrated in FIG. 9a, the outer and inner elements 10 and 20 are identical and arranged to be assembled in a mirrored arrangement. Once assembled, the end arrangement 100, 200 includes a frame formed by the frame 21 of the outer element 10 and the frame 22 of the inner element 20. It also includes a passage 70 located between the outer and inner elements 10 and 20 for circulating coolant between two orifices 48. Whereas the passage 70 is vertical in the example in FIGS. 6a to 6c, it is horizontal in this case. The passage 70 is located between two horizontal stiffeners 51, 50ₕ of the outer element 10 and two horizontal stiffeners 52, 50ₕ of the inner element 20. The vertical stiffeners 50ᵥ of the outer 10 and inner 20 elements have a variable thickness e. At the passage 70, this thickness e is less than half the gap e₀ between the wall 21 of the inner element 20 and the wall 11 of the outer element 10. In this example, the horizontal stiffeners 50ₕ have a width l₅ equal to a width l₀ of the end arrangement. In a variant (not illustrated), at least one width l₅ of one of the horizontal stiffeners is less than the width l₀ of the end arrangement. This example end arrangement is used in particular for a battery with fluid circulation on the lateral faces of the battery.

In the example batteries illustrated, the coolant comes from the cells, passes through at least one passage of an end arrangement, and exits into the channel. In a variant of the invention (not illustrated), the coolant comes from the channel in the battery, passes through at least one passage of an end arrangement, and exits towards the cells, being notably guided by grids between the cells. Thus, the outer element may include at least one orifice to form a coolant inlet. Similarly, the inner element may include at least one orifice to form a coolant outlet.

1. A battery for a mobility machine, including:
a plurality of cells;
a first end arrangement and a second end arrangement, at least one of the first and second end arrangements, preferably both, having at least one outer element and one inner element which are arranged to form, in the assembled state, a cellular structure, the inner element having a wall arranged to be in contact with a cell of the battery;
a channel for circulating coolant originating in or destined for the cells, the channel cooperating with at least one passage in one of the first or second end arrangements, the flow of coolant in the arrangement of one of the first or second end arrangements flowing in the opposite direction to the flow passing between the cells.

2. The mobility machine battery as claimed in claim 1, the outer element and/or the inner element including a series of vertical stiffeners, said vertical stiffeners being spaced apart regularly or otherwise along a horizontal dimension of said element.

3. The mobility machine battery as claimed in claim 1, the outer element and/or the inner element including a series of horizontal stiffeners, said horizontal stiffeners being spaced apart regularly or otherwise along a vertical dimension of said element.

4. The mobility machine battery as claimed in claim 1, the outer element and the inner element each having stiffeners, and the stiffeners of the outer element and the stiffeners of the inner element being arranged to cooperate with each other.

5. The mobility machine battery as claimed in claim 2, at least one of the stiffeners having a thickness less than a gap between the wall of the inner element and a wall of the outer element.

6. The mobility machine battery as claimed in claim 2, at least one height of one of the vertical stiffeners being less than a height of the end arrangement.

7. The mobility machine battery as claimed in claim 2, at least one width of one of the horizontal stiffeners being less than a width of the end arrangement.

8. The mobility machine battery as claimed in claim 1, said passage being arranged to circulate coolant originating in cells of the battery from at least one inlet.

9. The mobility machine battery as claimed in claim 8, said passage including at least one outlet for discharging the coolant.

10. The mobility machine battery as claimed in claim 1, the outer element and the inner element being identical and notably arranged to be assembled in a mirrored arrangement or head-to-tail.

11. The mobility machine battery as claimed in claim 1, the first and second end arrangements being fastened to the plurality of cells by at least one holding bar preferably having at least one oblong hole.

12. The mobility machine battery as claimed in claim 1, the wall of the inner element being made of a material having a low thermal conductivity, notably a material having a thermal conductivity of less than 5 W/m·K, notably a plastic material having a thermal conductivity of less than 5 W/m·K.

13. The mobility machine battery as claimed in claim 2, the outer element and/or the inner element including a series of horizontal stiffeners, said horizontal stiffeners being spaced apart regularly or otherwise along a vertical dimension of said element.

14. The mobility machine battery as claimed in claim 2, the outer element and the inner element each having stiffeners, and the stiffeners of the outer element and the stiffeners of the inner element being arranged to cooperate with each other.

15. The mobility machine battery as claimed in claim 3, at least one of the stiffeners having a thickness less than a gap between the wall of the inner element and a wall of the outer element.

16. The mobility machine battery as claimed in claim 3, at least one height of one of the vertical stiffeners being less than a height of the end arrangement.

17. The mobility machine battery as claimed in claim 3, at least one width of one of the horizontal stiffeners being less than a width of the end arrangement.

18. The mobility machine battery as claimed in claim 2, said passage being arranged to circulate coolant originating in cells of the battery from at least one inlet.

19. The mobility machine battery as claimed in claim 2, the outer element and the inner element being identical and notably arranged to be assembled in a mirrored arrangement or head-to-tail.

20. The mobility machine battery as claimed in claim 2, the first and second end arrangements being fastened to the plurality of cells by at least one holding bar preferably having at least one oblong hole.
